(19) United States
(12) Patent Application Publication
(10) Pub. No.: US 2011/0015977 A1
(43) Pub. Date: Jan. 20, 2011

(54) Internet advertisement-posting system

(76) Inventor: Tsukasa Nagao, Nagahama-shi (JP)

Correspondence Address: HENNEMAN & ASSOCIATES, PLC, 70 N. MAIN ST., THREE RIVERS, MI, 49093, US

(21) Appl. No.: 12/460,193

(22) Filed: Jul. 15, 2009

(51) Int. Cl. G06Q 30/00

(52) U.S. Cl. 705/14.14; 705/14.4; 705/14.73; 705/14.45; 705/14.15; 705/14.7; 705/14.68

(57) ABSTRACT

[Purpose]

To provide an advertisement with viewer's high interest and publishes a highly effective advertisement.

[Solution]

An internet advertisement-posting system comprising a server for managing and publishing an advertisement for a registered product requested by a client via a client terminal, an advertisement poster terminal for posting the advertisement on the server and a viewer terminal for viewing the advertisement managed by the server, the server, the advertisement-poster terminal and the viewer terminal connected each other via a network, wherein the server comprises a receiving means for receiving the advertisement posted from the advertisement poster terminal, a publishing means for publishing the advertisement as requested by the viewer terminal, an evaluation-request means for requesting the viewer terminal to evaluate the viewed advertisement, an evaluation-decision means for counting the evaluation obtained from the evaluation-request means so as to decide an comprehensive evaluation, a processing means for processing the advertisement based on an evaluation obtained from the evaluation-decision means and a reward-decision means for deciding a reward for an advertisement poster depending on the comprehensive evaluation obtained from the evaluation-decision means.

### BACKGROUND OF THE INVENTION

1. Field of the Invention

This invention relates to an internet advertisement-posting system for advertising a product with an advertisement made by a consumer, etc.

2. Description of the Related Art

Recently, companies utilize a network such as an internet as a tool for publishing their advertisement

A method for publishing the advertisement via the network is, for example, publishing the advertisement on a website launched by a company using a terminal thereof. However, by this method, a website viewer only finds the company's own products. Therefore, the viewer needs to visit another company's website and access an advertisement thereof to compare with another product in a same category when actually selecting a product, which requires great time and effort. In addition, it is difficult to compare advertisements on a plurality of websites.

For example, Japanese Patent Application Publication No. 2003-122790 discloses an advertisement-publishing system for publishing various product advertisements together by gathering advertisements from a plurality of companies in the terminal with which a website is launched.

Using said advertisement-publishing system, an advertisement viewer can view product advertisements of plurality of companies in one terminal so that it is possible to easily compare various products when actually selecting a product.

However, these advertisements were not new to a viewer because they were originally made to be published on other media such as TV or newspapers, and then modified for said system. Further, these advertisements were usually used over a certain period. Therefore, the viewer's interest is decreased, which results in that the advertisement is less effective.

In addition, these advertisements created by the company or the advertisement agency or the like strongly reflect their intention, so that they are likely to exaggerate the product effect or conceal a fault in the advertisement. Therefore, there was a problem of expressing an impression of a real product.

In view of the above situation, the purpose of the invention is to provide an internet advertisement-posting system with viewer's high interest and publishes a highly effective advertisement.

Further, the purpose of the invention is to provide an internet advertisement-posting system which publishes the advertisement having little difference with an impression of a real product.

### SUMMARY OF THE INVENTION

One embodiment of the present invention relates to an internet advertisement-posting system comprising a server for managing and publishing an advertisement for a registered product requested by a client via a client terminal, an advertisement poster terminal for posting the advertisement on the server and a viewer terminal for viewing the advertisement managed by the server, the server, the advertisement-poster terminal and the viewer terminal connected each other via a network, wherein the server comprises a receiving means for receiving the advertisement posted from the advertisement poster terminal, a publishing means for publishing the advertisement as requested by the viewer terminal, an evaluation-request means for requesting the viewer terminal to evaluate the viewed advertisement, an evaluation-decision means for counting the evaluation obtained from the evaluation-request means so as to decide an comprehensive evaluation, a processing means for processing the advertisement based on an evaluation obtained from the evaluation-decision means and a reward-decision means for deciding a reward for an advertisement poster depending on the comprehensive evaluation obtained from the evaluation-decision means.

Another invention of the present invention relates to the internet advertisement-posting system, wherein the published advertisement by the publishing means is a banner advertisement linked to the client terminal.

Another embodiment of the present invention relates to the internet advertisement-posting system, wherein the receiving means is able to receive the advertisement from the client terminal, wherein the publishing means alternately publishes the advertisement posted from the advertisement poster terminal and stored in the server and the advertisement provided from the client terminal as the banner advertisement.

Another embodiment of the present invention relates to the internet advertisement-posting system, wherein the publishing means comprises a counter for a number of visitors to the banner advertisement and alternately publishes advertisements posted from the advertisement poster terminal and stored in the server and the advertisement provided by the client terminal every certain period, wherein the advertisement with a lot of number of visitors during the certain period is selected by the processing means to be published.

Another embodiment of the present invention relates to the internet advertisement-posting system wherein the advertisement includes an advertisement for a non-registered product.

Another embodiment of the present invention relates to the internet advertisement-posting system wherein the publishing means comprises categorizing advertisements posted by the advertisement poster terminal into predetermined categories and publishing the categorized advertisement, respectively.

Another embodiment of the present invention relates to the internet advertisement-posting system wherein the publishing means comprising categorizing advertisements for the registered product and for the non-registered product into different categories and publishing the categorized advertisement, respectively.

Another embodiment of the present invention relates to the internet advertisement-posting system wherein the reward-decision means decides to reward the advertising poster terminal by a lottery in a certain period, said advertising poster terminal posting an advertisement with comprehensive evaluation over a certain level by the evaluation-decision means.

Another embodiment of the present invention relates to the internet advertisement-posting system wherein the reward-decision means decides not to give the reward for the advertisement for the non-registered product.

Another embodiment of the present invention relates to the internet advertisement-posting system wherein the processing means deletes an advertisement for the registered product with a comprehensive evaluation under a certain level by the evaluation-decision means after over second certain period from a posting time and an advertisement for the non-registered product after third certain period from the posting time.

Another embodiment of the present invention relates to the internet advertisement posting system wherein the reward decided by the reward-decision means is given to the advertisement poster terminal from the server without involving the client terminal.

Another embodiment of the present invention relates to the internet advertisement posting system wherein the server comprises a charging means for charging a participation fee on the advertisement poster terminal and a lottery means, wherein the lottery means rewards a total amount of a participation fee to the advertisement poster terminal selected by a lottery after the charging means confirms the payment of the participation fee from the advertisement poster terminal, said advertisement poster terminal posting the advertisement given an evaluation over a certain level of each registered product by the evaluation decision means.

Another embodiment of the present invention relates to the internet advertisement posting system wherein the server comprises a saving means for saving a part of the participation fee, wherein the lottery means rewards a total amount of a part of participation fee saved in the saving means by a second lottery to all the advertisement poster terminal after charging means confirms the payment of the participation fee from the advertisement poster terminal, said advertisement poster terminal posting the advertisement with an evaluation above a certain standard by the advertisement poster terminal.

Another embodiment of the present invention relates to the internet advertisement posting system wherein the server is connected to a substitutional publishing server for receiving and publishing the advertisement transmitted from the server via a network.

In one embodiment of the present invention, the server, the advertisement-poster terminal for posting the advertisement on the server and the viewer terminal for a consumer viewing the advertisement managed by the server are connected each other via a network, and the server comprises a receiving means for receiving the advertisement posted from the advertisement poster terminal and a publishing means for publishing the advertisement as requested by the viewer terminal. Therefore, the server can receive the advertisement from a general consumer who actually used the product so that the advertisement having little difference with an actual product impression can be published. Moreover, highly advertisement effect can be achieved because the advertisement poster such as the general consumer can create a new and highly interesting advertisement for the viewer.

In addition, the server comprises an evaluation-request means for requesting the viewer terminal to evaluate the viewed advertisement, an evaluation-decision means for counting the evaluation obtained from the evaluation-request means so as to decide an comprehensive evaluation and a processing means for processing the advertisement based on an evaluation obtained from the evaluation-decision means. Therefore, an advertisement poster will create a better advertisement for improving his/her evaluation, which results in that highly advertisement effect can be achieved because the general consumer can create the high interest advertisement for the viewer.

Furthermore, the server comprises a reward-decision means for deciding a reward for an advertisement poster depending on the comprehensive evaluation obtained from the evaluation-decision means. Therefore, the advertisement poster will create a better advertisement for obtaining a reward, which results in that the highly interesting advertisement for the viewer, so that the high advertisement effect can be achieved.

In another embodiment of the present invention, the published advertisement by the publishing means is a banner advertisement linked to the client terminal which requests the advertisement. Therefore, the viewer can easily access to the client terminal posting a detailed product information when viewing the banner advertisement and requiring more detailed information.

Yet in another embodiment of the present invention, the receiving means is able to receive the advertisement from the client terminal, wherein the publishing means alternately publishes the advertisement posted from the advertisement poster terminal and stored in the server and the advertisement provided from the client terminal as the banner advertisement. Therefore, not only the advertisement posted by the advertisement poster but also the advertisement created by the client can be published, so that the high quality advertisement can be selected and published so as to improve the high advertisement effect.

In another embodiment of the present invention, the publishing means comprises a counter for a number of visitors to the banner advertisement and alternately publishes advertisements posted from the advertisement poster terminal and stored in the server and the advertisement provided by the client terminal every certain period, wherein the advertisement with a lot of number of visitors during the certain period is selected by the processing means to be published. Therefore, the high quality banner advertisement is automatically selected and published so as to improve the high advertisement effect.

In another embodiment of the present invention, the advertisement includes an advertisement for a non-registered product. Therefore, the viewer can view advertisements for various products.

In another embodiment of the present invention, the publishing means comprises categorizing advertisements posted by the advertisement poster terminal into predetermined categories and publishing the categorized advertisement, respectively. Therefore, the viewer can easily search the product advertisement.

In another embodiment of the present invention, the publishing means comprises categorizing advertisements for the registered product and for the non-registered product into different categories and publishing the categorized advertisement, respectively. Therefore, searching the non-registered product is difficult compared to the registered product, so that the registered product can be differentiated from the non-registered product in terms of the advertisement effects. Thus, manufacturers or traders of the non-registered product are willing to register the product with which they deal. This results in promoting the registration thereof.

In another embodiment of the present invention, the reward-decision means decides to reward the advertising poster terminal by a lottery in a certain period, said advertising poster terminal posting an advertisement with comprehensive evaluation over a certain level by the evaluation-decision means. The reward is not always given to the advertisement poster when ranked in a high place. Therefore, it is possible to prevent the advertisement poster from viewing his/her advertisement repeatedly to improve the evaluation for the purpose of obtaining the reward. Further, the reward is given only to the advertisement poster whose evaluation is over a certain level. Therefore, an effect to generate a motivation for creating the advertisement by the reward is not lost.

In another embodiment of the present invention, the reward-decision means decides not to give the reward for the advertisement for the non-registered product. Therefore, the advertisement poster can obtain no rewards by posting the advertisement for non-registered product so that the non-registered product is not likely to be posted. Thus, there will be a big difference of the advertisement effect between the registered product and the non-registered product, which leads the trader to register the non-registered product with which they deal.

In another embodiment of the present invention, the processing means deletes an advertisement for the registered product with a comprehensive evaluation under a certain level by the evaluation-decision means after over second certain period from a posting time and an advertisement for the non-registered product after third certain period from the posting time. Therefore, a capacity of a storing means can be obtained.

In addition, by erasing the advertisement of the registered product that their comprehensive evaluation obtained from the evaluation-decision means is lower than the certain level, the high-evaluated advertisement can stay longer and the effect of the advertisement can be highly maintained.

Moreover, the advertisement of the non-registered product will be deleted after the third certain period without being evaluated by the evaluation-decision means, so that the advertisement poster motivation to post such advertisement will be decreased. Therefore, there will be a big difference of the advertisement effect between the registered product and the non-registered product. The difference therebetween will be much greater when the third certain period is less than the second certain period. Thus, the traders of the non-registered product are willing to register the product thereof.

In another embodiment of the present invention, the reward decided by the reward-decision means is given to the advertisement poster terminal from the server without involving the client terminal. Therefore, the client is not involved in a payment of the reward, so that the client's work can be reduced after requesting the advertisement. In addition, it is possible to skip reporting the advertisement decided by the reward-decision means to the client.

In another embodiment of the present invention, the server comprises: a charging means for charging a participation fee on the advertisement poster terminal; and a lottery means, wherein the lottery means rewards a total amount of a participation fee to the advertisement poster terminal selected by a lottery after the charging means confirms the payment of the participation fee from the advertisement poster terminal, said advertisement poster terminal posting the advertisement given an evaluation over a certain level of each registered product by the evaluation decision means. Therefore, the advertisement poster selected by the lottery can obtain the award aside from that of the advertisement client, so that the advertisement poster motivation for creating the advertisement will be improved. This results in obtaining a better-quality advertisement.

In another embodiment of the present invention, the server comprises a saving means for saving a part of the participation fee, wherein the lottery means rewards a total amount of a part of participation fee saved in the saving means by a second lottery to all the advertisement poster terminal after charging means confirms the payment of the participation fee from the advertisement poster terminal, said advertisement poster terminal posting the advertisement with an evaluation over a certain standard by the advertisement poster terminal. Therefore, the advertisement poster selected by the second lottery can obtain the award aside from that of the advertisement client, which improves the advertisement poster motivation for creating the advertisement with its game element. Moreover, this results in providing a better quality advertisement because the advertisement will not be a subject for the second lottery if the evaluation of the advertisement by the evaluation-decision means does not meet a certain evaluation standard.

In another embodiment of the present invention, the server is connected to a substitutional publishing server for receiving and publishing the advertisement transmitted from the server via a network, so that the advertisement can be published and stored on the terminal except the server (the substitutional publishing server). Therefore, the effect of publishing and storing the advertisement can be improved.

In addition, the posted advertisement can also be used as an advertisement for TV when the substitutional publishing server is connected thereto.

### BRIEF DESCRIPTION OF THE DRAWINGS

Hereinafter, detailed description of preferred embodiment of the present invention will be described.

FIG. 1 is a system configuration diagram showing an embodiment of the internet advertisement-posting system according to the present invention.

FIG. 2 is a flow diagram showing a performance of the internet advertisement-posting system.

FIG. 3 is an illustration diagram showing an operation when selecting a product.

FIG. 4 is another illustration diagram showing an operation when selecting a product.

FIG. 5 is a diagram showing an example of a monitor displaying the advertisement.

FIG. 6 is a diagram showing another example of a monitor displaying the advertisement.

### DETAILED DESCRIPTIONS

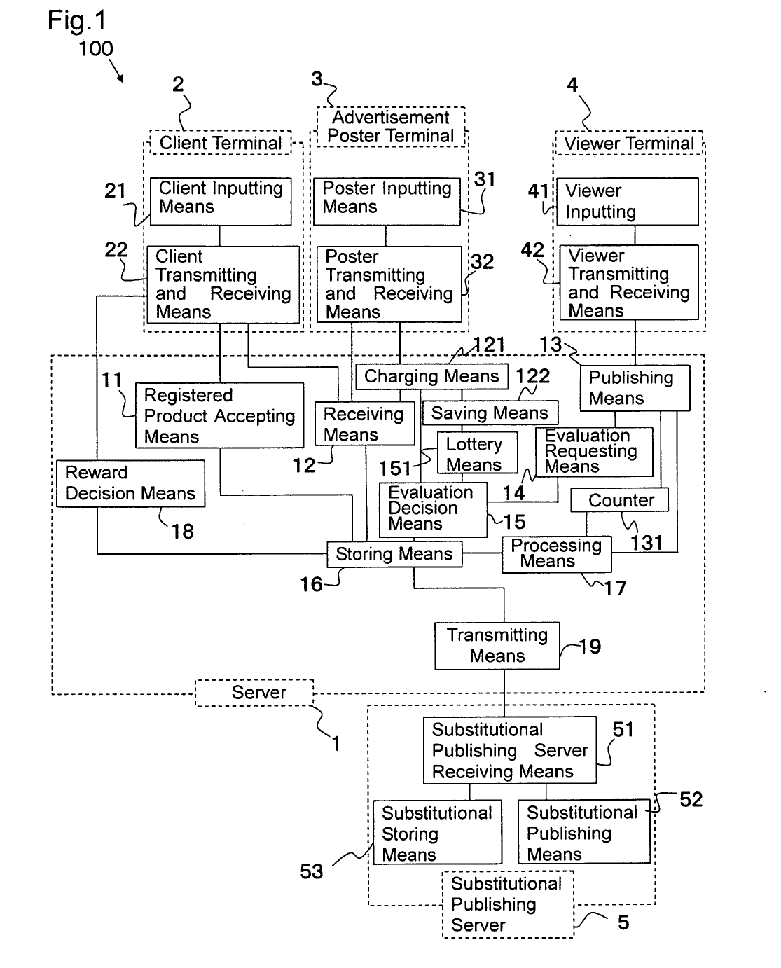

FIG. 1 is a system configuration diagram showing an embodiment of the internet advertisement-posting system according to the present invention.

In an internet advertisement-posting system (100) in FIG. 1, a server (1) is connected via a network to: a client terminal (2) which an advertisement client such as a company uses; an advertisement poster terminal (3) provided for creating and posting the advertisement; a viewer terminal (4) for a viewer such as a consumer; and a substitutional publishing server (5). Note that only single client terminal (2), advertisement poster terminal (3), viewer terminal (4) and substitutional publishing server are shown in the drawing, however, there are actually several terminals and they are connected to the sever (1) via a network.

The server (1) is a computer for managing and publishing the advertisement, for example by setting up a website. The server (1) provides the advertisement when a CPU executes a predetermined program stored in a memory, an external storage unit, or the like. It also comprises a registered product-accepting means (11), a receiving means (12), a publishing means (13), an evaluation-request means (14), an evaluation decision means (15), a storing means (16), a processing means (17), a reward decision means (18), a transmitting means (19) and the like. The details will be described hereinafter.

The client terminal (2) is the terminal of a client (an advertisement client) for requesting the server (1) to advertise for a specific product.

The client terminal (2) comprises a client input means (21) such as a keyboard and a client transmit and receive means (22) for communicating with an external device. The product which is requested to be advertised is input by the client input means (21) and transmitted to the server (1) by the client transmit and receive means (22) via the network.

The product requested to be advertised by the client terminal (2) is registered as the registered product in the storing means (16) of the server (1), and is published by the publishing means (13).

For example, the advertisement client such as a manufacturer requests the advertisement for their product to the server from their terminal (client terminal (2)). Here, the requested advertisement is not limited to the advertisement for the material subject. It can also be the advertisement for a tour requested by a travel agency or the advertisement for a local sightseeing spot requested by an alliance cooperation.

The advertisement poster terminal (3) is the terminal of the advertisement poster for providing the advertisement for the registered product requested by the client terminal (2), and comprises a poster input means (31) for inputting the product advertisement and a client transmit and receive means (32) for communicating with an external device.

The advertisement poster creates the advertisement for the product registered in the server (1), inputs the created advertisement using the poster input means (31) and then provide it with the server using the poster transmit and receive means (32) via the network. The poster input means (31) such as a keyboard, a camera and a video camera inputs the advertisement including a comment, a product photo, a moving image and so on.

Preferably the advertisement poster may be a general consumer because the advertisement can be affected by an actual experience of the general consumer on using the product so that the advertisement having an exaggeration and concealing a fault can be decreased. Note that the advertisement poster is not limited to the general consumer but may be such as an advertisement agency or a creator.

In addition, the advertisement for the non-registered product may be posted by the advertisement poster terminal (3) so that the server (1) can publish many products.

The advertisement poster terminal (3) includes for example, a computer such as a desktop PC, and a mobile terminal such as a mobile phone and a Personal Digital Assistance (PDA).

Especially, when the mobile terminal is available, the advertisement poster can create and post the advertisement easily so that the many advertisements are preferably posted to the server (1). This is because that the advertisements which can draw viewer's high interest can be easily gathered by posting a lot of advertisements so that the advertisement effect is improved.

The viewer terminal (4) is a terminal of a viewer for viewing the published product advertisement by accessing the server (1), and comprises a viewer transmit and receive means (42) for communicating with the external terminal. The viewer receives information such as the product advertisement which is managed in the server (1) by the viewer transmit and receive means (42) and displays it on a display part such as a display for viewing.

In addition, the viewer terminal (4) comprises a viewer input means (41) of the viewer for inputting the evaluation on a request from the evaluation request means (14). The information input by the viewer input means (41) is transmitted to the server (1).

The viewer terminal (4) includes for example, a computer such as a desktop PC, and a mobile terminal such as a mobile phone and a Personal Digital Assistance (PDA).

The substitutional publishing server (5) is a terminal for publishing the advertisement managed in the server (1) and comprises a substitutional publishing server receiving means (51) for receiving the advertisement transmitted by the transmit means (19) of the server (1), and a substitutional publishing means (52) for publishing the advertisement received by the substitutional publishing server receiving means (51). By having the substitutional publishing server (5), the advertisement posted by the advertisement poster terminal (2) can be published on and stored in except the server (1) (the substitutional publishing server (5)). Therefore, the effect of publishing and storing the advertisement can be more improved.

In addition, the substitutional publishing server (5) may comprise a substitutional storing means (53), because the advertisement can be stored therein instead of the storing means (16) of the server (1) (described hereinafter), which results in reducing the server (1)'s burden.

Next, the server (1) will be explained by explaining a registered product accepting means (11), a receiving means (12), a publishing means (13), an evaluation-request means (14), an evaluation-decision means (15), a storing means (16), a processing means (17), reward-decision means (18) and transmitting means (19), which are comprised in the server (1).

Note that each of the means (11) to (19) maybe composed of a single computer or a plural of computers connected each other via a network.

The registered product accepting means (11) is for accepting an advertising request from the client terminal (2). The requested advertisement is registered to the storing means (16) as the registered product, and then published.

The receiving means (12) is for receiving the advertisement provided from the advertisement poster terminal (3) and the received advertisement by the receiving means (12) is processed by the processing means (17).

The receiving means (12) may comprise a charging means (121) for charging a participation fee to the advertisement poster terminal (3) and a saving means (122) for saving a part of the participation fee paid to the charging means (121).

The publishing means (13) is for transmitting information to other terminal (such as the viewer terminal (4)) to publish the advertisement. The processed advertisement is also published by the processing means (17) on the request of the viewer terminal (4). Further, the registered product is also published by the publishing means (13). Furthermore, the publishing means (13) may comprise a counter (131) for counting a number of visitors to the advertisement published by the publishing means (13). Note that the publishing means (13) is connected to the viewer terminal (4) only in FIG. 1, but it is obviously connected to the other terminals when publishing the information on other terminal.

In addition, the posted advertisement may be used as a TV advertisement when the publishing means (13) is connected to TV.

The evaluation-request means (14) is for requesting the viewer to evaluate a content of the advertisement when viewing the advertisement. In particular, the evaluation-request means (14) requests the viewer to evaluate the content of the advertisement by publishing its evaluation standard using publishing means (13).

The evaluating method by the evaluation-request means (14) may include the method for requesting points for the advertisement. In addition, a comment as well as points for the advertisement may also be requested.

The evaluation-decision means (15) is for counting the evaluation obtained from the evaluation-request means (14) so as to decide a comprehensive evaluation for the advertisement.

The evaluation-decision means (15) may comprise a lottery means (151) for giving an award by a lottery to the advertisement poster whose advertisement meets a certain evaluation standard after the charging means (121) confirms the payment from the advertisement poster.

In addition, the storing means (16) is for managing information held by the server (1) and is used when the evaluation-decision means (15) counts the evaluation for each advertisement. In particular, the advertisement posted from the advertisement poster terminal (3), the evaluation of the advertisement, an identification data of the advertisement poster or the client and so on are stored in the storing means (16). Furthermore, the storing means (16) is divided into regions for storing each information. The storing regions in the storing means (16) are such as: a product storing region for storing the registered product information; an advertisement storing region for storing the posted advertisement; a comprehensive evaluation storing region for storing the comprehensive evaluation by the evaluation-decision means (15); a poster identification data storing region for storing the advertisement poster identification data; and a viewer identification data storing region for storing the viewer identification data.

The storing means (16) may include such as hard disk, MO, CD-RW, and DVD-RW. The storing means (16) may be composed of a plural of medium. For example, each storing region is provided with a media for storing, respectively.

The processing means (17) is for processing the advertisement based on the comprehensive evaluation by the evaluation-decision means (15) and the processed advertisement is published by the publishing means (13).

The processing method is, for example, to process the advertisement to be published in descending order based on the comprehensive evaluation.

By processing and publishing the posted advertisement based on the comprehensive evaluation, the advertisement poster tries to improve their own evaluation so that the motivation for creating the advertisement will be enhanced. Therefore, a number of posted advertisements will be increased. Furthermore, advertisement poster tries to post the advertisement with high evaluation so that a quality of the published advertisement will be improved and the many advertisements with viewer's high interest can be published. Therefore, the advertisement effect will be improved.

In addition, publishing the advertisement in descending order can make the viewer to easily view the high quality advertisement which is favored by other viewers.

Other processing method is to line up the posted advertisements in order of arrival at the receiving means (12).

The reward-decision means (18) is for deciding the reward for each advertisement poster based on the comprehensive evaluation obtained from the evaluation-decision means (15). The reward decided by the reward-decision means (18) is transmitted to the client transmit and receive means (22) of the client terminal (2) so as to report the reward information to the client, and then the advertisement poster is given the reward from the client.

The transmitting means (19) is for transmitting the advertisement posted from the advertisement poster terminal (3) to the substitutional publishing server receiving means (51) of the substitutional publishing server (5) based on the comprehensive evaluation obtained from the evaluation-decision means (15). The transmitted advertisement is stored and managed in the substitutional storing means (53) of the substitutional publishing server (5), and published by the substitutional publishing means (52).

Next, the internet advertisement-posting system (100) according to the present invention will be described in detail by explaining an operation thereof.

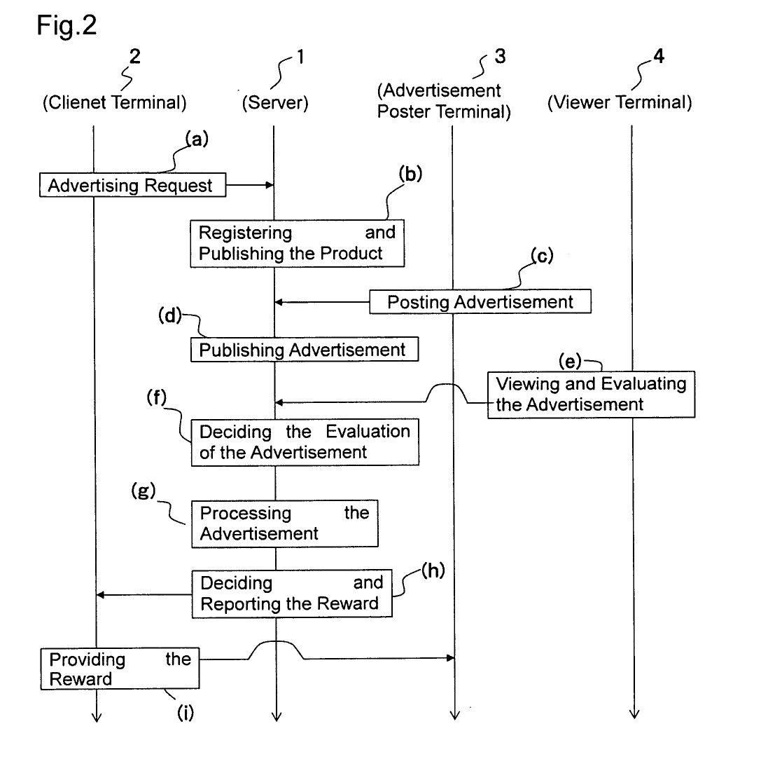

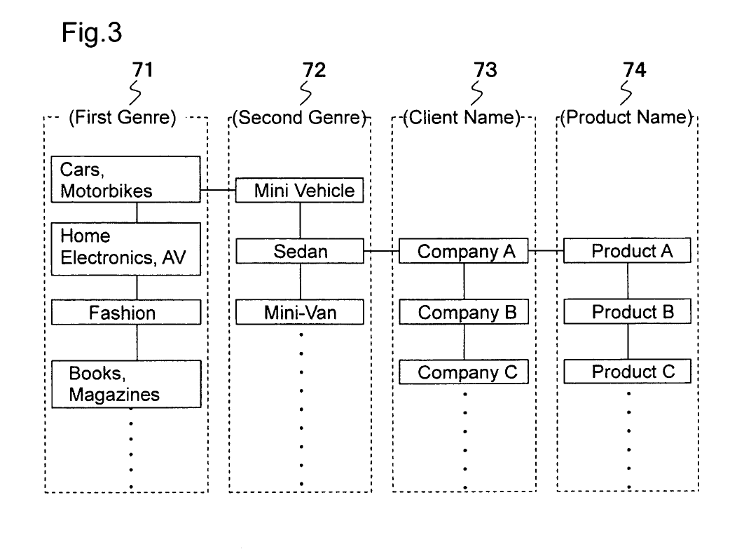

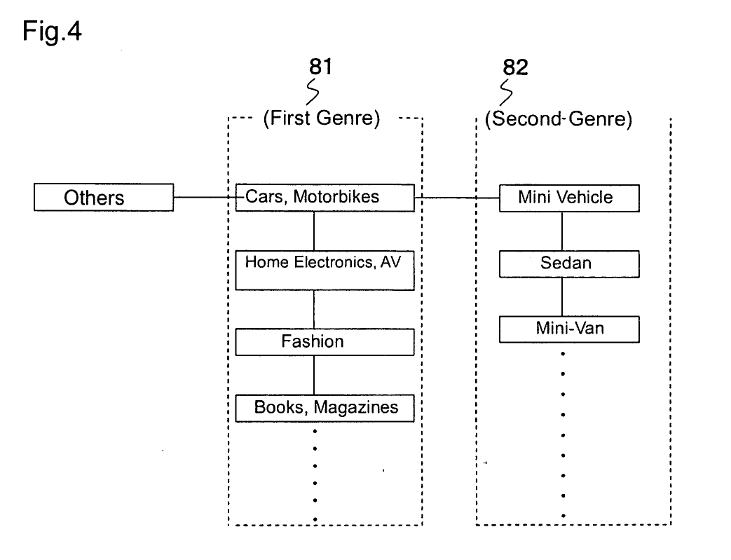

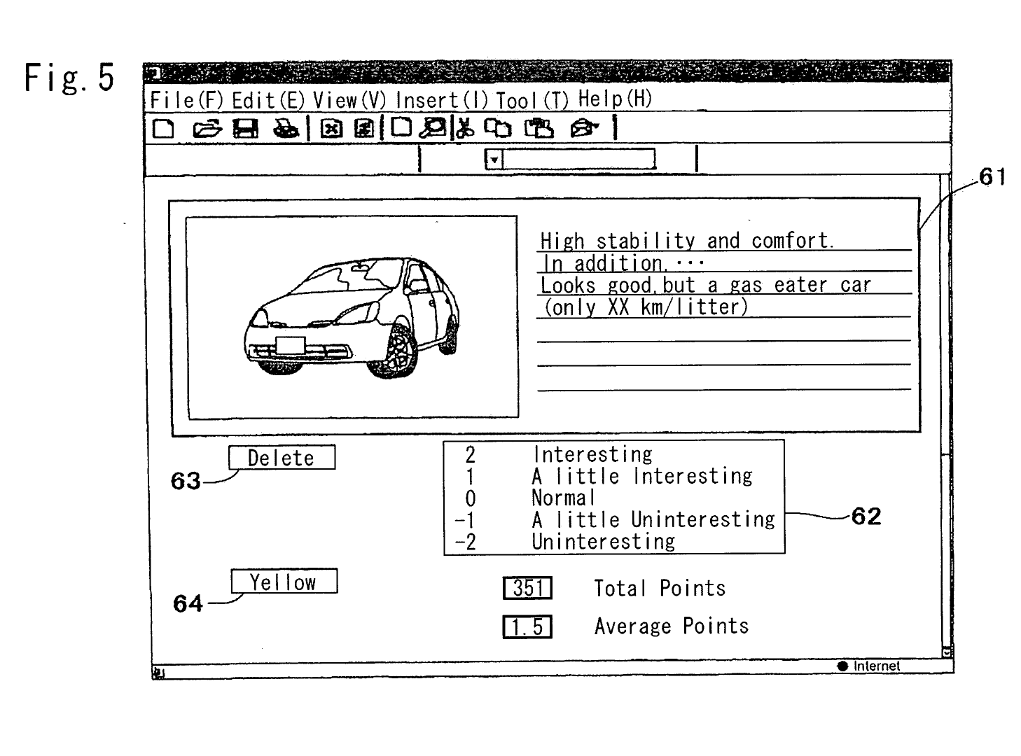

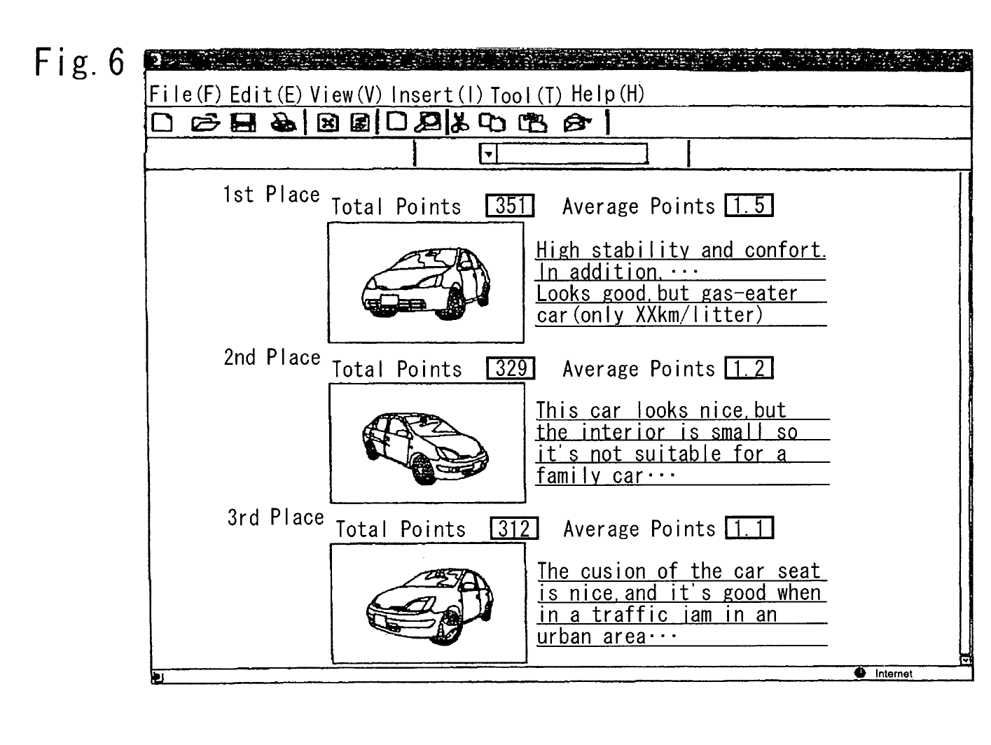

FIG. 2 is a flow diagram showing a performance of the internet advertisement-posting system, and (a) to (i) in FIG. 2 show a respective step thereof. FIG. 3 and FIG. 4 are illustration diagrams for explaining an operation when selecting the product. FIG. 5 and FIG. 6 are diagrams showing an example of a monitor displaying the advertisement.

Hereinafter, the explanation will be carried out based on FIG. 1 and FIG. 2, conveniently FIG. 3 and FIG. 6.

In the internet advertisement-posting system (100), the registered product-accepting means (11) of the server (1) receives the advertisement request for the product or the like which requires to be advertised from the client terminal (2) (step (a)). In particular, the client inputs the requesting product using the client input means (21), and transmits it to the server (1) using the client transmit and receive means (22).

Then, the registered product-accepting means (11) of the server (1) receives the information from the client transmit and receive means (22), the product requested for the advertisement is stored (registered) in the product storing region of the storing means (16) as a registered product, and the publishing means (13) reads and publishes the information of the registered product stored in the product storing region (step (b)).

Note that the client terminal and the server are connected via a network in this embodiment and the advertisement is also requested via a network. However, the advertisement request is not limited to the method via a network such as the internet. For example, it may include a written or verbal request.

Meanwhile, the advertisement poster creates the advertisement for the registered product published by the server (1), and posts the created advertisement to the server (1) from his/her terminal (the advertisement poster terminal (3)) (step (c)). In particular, the advertisement poster inputs the created advertisement using the poster input means (31) and transmits it to the receiving means (12) of the server (1) with the poster transmit and receive means (32). The advertisement poster also creates and posts the advertisement for the non-registered product. Then, the posted advertisement is stored in the advertisement storing region of the storing means (16).

In this case, the advertisement transmitted from the poster transmit and receive means (32) is provided subdivided into categories such as genre, client (company), product, price, size (decided by the server (1)), and is received by the receiving means (12). In particular, when the advertisement poster posts the advertisement, the advertisement poster terminal (3) is set to display the subdivided product into each category so that the advertisement poster can post the advertisement by selecting the corresponding category. For example, as shown in FIG. 3, there are 4 categories: a first genre (71) in which all advertisements are subdivided into items such as “Cars and Motorbikes”, “Home Electronics and AVs”, etc.; a second genre (72) in which the item in the first genre (71) is further subdivided into items such as “Mini Vehicle”, “Sedan”, etc.; a client name (73) in which the item in the second genre is further subdivided into items such as “Company A”, “Company B”, etc.; and a product name (74) in which the products of the client is subdivided into items such as “Product A”, “Product B”, etc. The advertisement poster selects the desired genre for posting advertisement from the first genre (71), then selects the second genre (72), the client name (73), and the product name (74) and selects the desired product for posting advertisement. Therefore, the advertisements are easily subdivided. Also, the viewer can easily search the published advertisement.

In addition, the registered product and the non-registered product may be subdivided into different categories. Thus, they can be processed separately in an easy way.

The type of the created advertisement is not limited to but they may be, for example, a comment such as a feedback or an evaluation about the product, and an image such as a motion picture, a photo and an illustration. The comment such as the feedback or the evaluation makes the viewer to subjectively judge a product value, and the image makes the viewer to visually recognize the product. Therefore, the viewer's willingness to buy will be increased. Especially, the motion picture can effectively make the viewer to recognize the product because it can express the motion of the product as it is. Therefore, by not limiting the form of the advertisement, various advertisements will be created. This enables to highly improve the viewer's interest so that the advertisement effect will be improved. In addition, publishing various advertisements bring various ideas of the advertisement, therefore the quality of the future posting advertisement will be improved.

Furthermore, the advertisement poster can easily create the advertisement by describing a comment or the like on a format which is preliminarily prepared in advance and published by the publishing means (13). Therefore, the advertisement poster can easily create the advertisement and the number of the posted advertisement can be increased.

Preferably, the server (1) obtains the identification data of the advertisement poster when receiving the advertisement so that the identification data may be utilized when giving the reward later.

For example, the receiving means (12) requests the identification data of the advertisement poster to the advertisement poster terminal (3) when receiving the posting of the advertisement. The server (1) can also be set that once the identification data is entered, a password is issued to the advertisement poster so that they do not need to enter the identification data again when posting the advertisement.

The identification data of the advertisement poster includes such as: E-mail or IP address of the advertisement poster terminal, address, name, sex, age, and credit-card information of the advertisement poster. The identification data may be stored in the poster identification data storing region of the storing means (16) correlating with the advertisement stored in the advertisement storing region.

The advertisement posted from the advertisement poster terminal (3) is published by the publishing means (13) (step (d)). In particular, the publishing means (13) reads and publishes the advertisement stored in the advertisement storing region of the storing means (16).

At this time, the advertisement is also subdivided into categories in the publishing means (13) as well as the receiving means (12) to be published. In particular, the advertisement subdivided into each category is received and stored in the advertisement storing region of the storing means (16), then published by the publishing means (13). Thus, a desired advertisement can be easily searched. For example, as shown in FIG. 3, when there are 4 categories of the first genre (71), the second genre (72), the client name (73) and the product name (74), the viewer selects the appropriate genre to the desired advertisement from the first genre (71), and then selects the second genre (72), the client name (73) and the product name (74) so that the viewer can easily search the advertisement of the desired product.

In addition, preferably, the registered products are subdivided into categories by the product, and the non-registered products are subdivided into one category, for example “others” category. The “others” category is set not to be subdivided as detailed as the category of registered product. For example, as shown in FIG. 4, when the “others” is selected, the advertisement is subdivided into a first genre (81) and a second genre (82), however, it will not be subdivided into a category of a client name or product name. That is, a method for subdividing the advertisement into the category of the registered product or the non-registered product should be distinguished. Therefore, it is difficult for the viewer to search the product because of the less detailed category of the non-registered product while the advertisement for the registered product can be easily searched using detailed categories.

That is, there is a difference in easiness when searching the registered product and non-registered product, so that there will also be a big difference in the advertisement effect.

Therefore, there is a difference in the advertisement effect between the registered product and the non-registered product even though they are published by the same terminal. This affects sales of the product so that it is not preferable for the traders of the non-registered product. Thus, they are willing to request the advertisement for the product with which they deal. This results in promoting the advertisement request. By increasing the advertisement request, the registered product for rewarding will be increased, so that the advertisement posting will also be increased. Increasing the published advertisement improves the viewer's satisfaction level.

The advertisement published in step (d) is received by the viewer transmit and receive means (42) and displayed on the display part such as a display so as to be viewed by the viewer (step (e)). Also, the viewer is requested by the evaluation-request means (14) to evaluate the advertisement after viewing. The viewer evaluates the advertisement by imputing their evaluation with the viewer input means (41).

A method for requesting the evaluation by the evaluation-request means (14) is, for example as shown in FIG. 5, that the viewer clicks an evaluation button (62) provided below the advertisement display part (61) depending on the contents of the advertisement. In this case, the evaluation button (62) is included as a part of the viewer input means (41). In FIG. 5, the advertisement is evaluated by the viewer using the evaluation button (62) for selecting numbers such as “2 (interesting) 1 (a little interesting), 0 (normal), −1 (a little uninteresting), −2 (uninteresting)”. In addition, the advertisement may be evaluated by providing the evaluation button (62) for each evaluation item such as appearance, content and impact. Further, at the same time, a comment for the advertisement may be requested. In this case, a means for giving the award (not shown) by the lottery to the viewer who clicked the evaluation button may be included for promoting the viewer's evaluation.

In addition, counting a number of the visitor to the advertisement may be considered as the evaluation.

The evaluation obtained from the evaluation-request means (14) is counted by the evaluation-decision means (15), and then the comprehensive evaluation is determined (step (f)).

Then, the posted advertisement is processed by the processing means (17) depending on the comprehensive evaluation (step (g)). For example, as shown in FIG. 6, the advertisement which is ranked according to the evaluation is processed to be published in descending order. Furthermore, the advertisement ranked over a certain level may be published emphatically.

By processing the posted advertisement based on the evaluation, the advertisement poster wishes to improve their evaluation so that the motivation for creating the advertisement will be increased. Therefore, the quality of the published advertisement will be improved. In addition, a number of posted advertisements will be increased.

The comprehensive evaluation decided by the evaluation-decision means (15) is stored in the evaluation storing region of the storing means (16) correlating with the advertisement stored in the advertisement storing region, then is appropriately read, for example, when processing the advertisement by the processing means (17).

Furthermore, the evaluation-request means (14) may request the evaluation in step (e) whether the advertisement should be deleted or not. The processing means (17) may process the advertisement to be deleted depending on the evaluation. By requesting the evaluation, the posted advertisement including a description of too much accusation of the product or a description of an irrelevant to the product may be deleted. One way of requesting the deletion is, as shown in FIG. 5, for example, providing a deleting button (63) which is pushed by the viewer. The processing means (17) is able to delete the advertisement which the deleting button (63) was pushed over certain times. In this case, a warning light (64) maybe provided to indicate a risk of deleting depending on how many times the deleting button (63) was pushed. For example, the warning light (64) may be changed into blue, yellow and red with increasing the number of the pushing of deleting button (63).

In addition, a standard may be set to automatically delete the advertisement when the evaluation by the evaluation-decision means is under a certain level. Thus, the low evaluated advertisement may be eliminated so that only the high evaluated advertisement may stay. Therefore, the effect of the advertisement may be improved.

Also, the client and an administrator may obtain a right to delete the advertisement.

Furthermore, the deleted advertisement may be set to be transmitted to the client terminal (2) (the client transmit and receive means (22)). Because analyzing the advertisement deleted by the client is useful for a verification of a complaint for the product and is available for a data for developing a new product.

In addition, the evaluation requesting means (14) is preferably set to obtain the identification data of the viewer terminal (4) when requesting the evaluation. Obtaining the identification data of the viewer terminal (4) may identify the viewer whether he/she once made the evaluation on a specific advertisement or not. Therefore, it is possible to prevent the viewers from unreasonably increasing the evaluation for the advertisement created by them, and from unreasonably decreasing the evaluation for the advertisement created by other person. The identification data of the viewer is stored in the viewer identification data storing region of the storing means (16) so as to identify the viewer whether he/she once made the evaluation or not by verifying the identification data of the viewer terminal (4) newly connected to the server (1).

In addition, the server (1) decides the reward by the reward-decision means (18) for each advertisement and transmits a reward information to the client transmit and receive means (22) so as to inform the client of the decided reward (step (h)). In particular, the reward is decided by reading the advertisement stored in the advertisement storing region and the comprehensive evaluation (such as a point or rank) stored in the comprehensive evaluation storing region. Then the reward is given to the advertisement poster based on the decision of the reward-decision means (18) (step (i)). Therefore, the motivation for creating the advertisement will be more increased. In particular, the reward is reported to the client along with the identification data of the advertisement poster whose advertisement is ranked in a certain level. Then, the client gives the reward to the advertisement poster.

The rewards may include such as cash, coupon, gift voucher, and client gift voucher.

The reward does not have to be given by the client, but the administrator of the server (1) may give the reward directory to the advertisement poster without involving the client, so that the client does not have to go through a procedure to give the reward to the advertisement poster. For this reason, a client's burden after requesting the advertisement maybe decreased, which results in a reduction of a labor cost. Giving the reward by the administrator may save the procedure to report the advertisement decided by the reward-decision means (18) to the client (step (h)), so that the working efficiency will be more promoted. Furthermore, storing the information of the decided reward or information whether the reward was actually given or not in the storing means (16) of the server (1) may unify the management of the reward information so that the working efficiency will be more promoted.

In addition, the reward may be given periodically to the advertisement poster whose evaluation is over a certain level. The advertisement poster whose advertisement is in a higher rank is not always given the reward because the lottery decides the advertisement poster to give the reward or not. Therefore, it is possible to prevent the advertisement poster from repeatedly viewing the advertisement created by his/herself for improving the evaluation thereof for obtaining the reward. Furthermore, an effect of inducing the motivation for creating the advertisement caused by giving the reward is not lost, because the reward is only given to the advertisement poster over a certain level.

Meanwhile, it is preferable that the reward decision means (18) does not decide and give the reward for the advertisement for the non-registered product. Therefore, the motivation for creating the advertisement for the non-registered product is difficult to be improved so that the quality thereof is decreased compared to the advertisement for the registered product and there will be a big difference of the advertisement effect between the registered product and the non-registered product. Therefore, this promotes the trader dealing with the non-registered product to request the advertisement thereof.

In addition, preferably, the processing means (17) deletes the advertisement from the advertisement storing region of the storing means (16) after a certain period from posting. Thus, an old advertisement will be deleted so that an amount of a capacity of the storing means (16) is available for a long time.

Also, it is preferable that the advertisement for the registered product is set to be deleted only when the comprehensive evaluation thereof after a certain period obtained from the evaluation-decision means (15) is under a certain level. Therefore, the high-evaluated advertisement (the advertisement which the comprehensive evaluation is over a certain level) may stay for a long time and the high advertisement effect may be maintained.

Meanwhile, it is preferable that all the advertisement for the non-registered product will be deleted in a shorter period than that of the registered product. Thus, if the high quality advertisement is posted, relatively it will be deleted sooner so that the advertisement poster's motivation for creating the advertisement for the non-registered product will be decreased and the quality thereof will be lower compared to that of the registered product. Therefore, there will be a big difference of the effect of the advertisement between the registered product and the non-registered product, which results in promoting the advertisement request for the product of the trader dealing with the non-registered product.

In addition, not shown in FIG. 2, the advertisement posted by the advertisement poster terminal (3) is transmitted to the substitutional publishing server (5) by the transmitting means (19). Then, the transmitted advertisement is received by the substitutional publishing server (51), stored and managed in the substitutional storing means (53) and published by the substitutional publishing means (52) (step (j)).

Thus, the posted advertisement from the advertisement poster terminal (3) maybe stored and managed like the above without using the server (1), so that an amount of the capacity thereof may be maintained.

The step (a) from step (j) are not limited to but described to be carried out in order, however, each step may be carried out appropriately depending on a configuration.

In addition, not shown in FIG. 2, the receiving means (12) may receive not only the advertisement posted by the advertisement poster terminal (3) but also the advertisement provided from the advertisement terminal (2) from the client transmit and receive means (22).

The advertisement posted by the advertisement poster terminal (3) or provided from the client terminal (2) and published by the publishing means (13) may be a banner advertisement linked to the client terminal (2) of the client of the advertised product. The banner advertisement is a picture of the product advertisement (a banner) inserted on a website and the viewer jumps to another website (the client terminal (2) or the server (1)) on which the advertising product appears by clicking the banner.

By applying the banner advertisement, the viewer can easily access to the client terminal (2) in which the detailed information of the product of the advertisement is published when the viewer wants to know more detailed information after viewing the advertisement.

The publishing means (13) alternately publishes the advertisement posted by the advertisement poster terminal (3) and the advertisement provided from the client terminal (2) in every certain period such as 3 days or a week.

The publishing means (13) selects the top visited advertisement counted by the counter (131) in every certain period and publishes it for a long time (1 to 3 months, for example).

That is, the advertisement provided by the advertisement client such as a company and the advertisement posted by the poster is published in a certain period (testing period), and the advertisement which obtained more viewers' interests may be published for a long time.

After published for a long time (1 to 3 months), the above operation is repeated again, and the top visited advertisement in a certain period will be published by the publishing means (13) for a long time.

Therefore, a high-quality advertisement is always be published so that the high effect of the advertisement may be obtained.

Furthermore, not shown in FIG. 2, the advertisement poster may pay a participation fee to the charging means (121) provided to the receiving means (12).

The advertisement poster confirmed the payment of the participation fee by the charging means (121) may obtain the total amount of the participation fee for each registered product if the posted advertisement is selected by the lottery means (151) when the evaluation of the posted advertisement by the evaluation-decision means (15) is in a high rank in each registered product.

In this case, the advertisement poster terminal (3) selected by the lottery means (151) may be identical or not identical to the advertisement poster terminal (3) which is given the reward by the evaluation decision means (15).

The total amount of the participation fee may be a total amount of the charged fee or a remaining amount of the charged fee that a part of which is divided to such as the client or the saving means (122) (described hereinafter). The participation fee is not limited to but may be, for example 100 yen to 1000 yen, which is easy to pay, and the total amount thereof will be expensive. Therefore, many advertisement posting can be promoted.

Thus, the motivation of the advertising poster for creating the advertisement may be improved so that the high quality advertisement may be achieved.

The evaluation by the evaluation-decision means (15) is not limited but may be a total evaluation points such as “2 (interesting), 1 (a little interesting), 0 (normal), −1 (a little uninteresting), −2 (uninteresting)” by the evaluation button (62) in a certain period (such as a month).

The total amount of the participation fee as a reward may be saved and carried over to a next lottery if the advertisement poster terminal (3) selected by the lottery means (151) does not pay the participation fee to the charging means (121). Therefore, the reward of the next lottery will be expensive so that the motivation of the advertisement poster for creating the advertisement will be increased.

In addition, the total amount of the participation fee may be disclosed. This results in improving the motivation of the advertisement poster for creating the advertisement.

Note that the evaluation by the evaluation decision means (15) is carried out for each registered product, but it is not limited to but may be also carried out for each category such as the genre or the client name.

In addition, a part of the participation fee charged to the charging means (121) may be saved in the saving means (122).

After the charging means (121) confirms the payment of the participation fee from the advertisement poster, the advertisement poster obtains a right of the second lottery by the lottery means (151) to obtain the award which is the total amount of the part of the participation fee saved in the saving means (122) when the evaluation of the posted advertisement by the evaluation-decision means (15) meets a certain evaluation standard.

The advertisement poster selected by the second lottery can obtain the total amount of the part of the participation fee saved in the saving means (122) aside from the reward that the client will pay to the advertisement poster.

Note that the part of the participation fee is not limited to, but preferably it may be 10% thereof.

Preferably, the second lottery is done in every term which is longer than a certain period such as a month as described above, for example, a year.

Thus, the motivation of advertisement poster for creating the advertisement will be increased because of the possibility of obtaining the award aside from the reward from the advertisement client and a game element. Furthermore, this results in providing better quality advertisement because the advertisement will not be selected by the lottery unless the evaluation by the evaluation-decision means (15) does not meet the certain evaluation standard.

Note that the certain evaluation standard is not limited to but it may include the advertisement whose total evaluation points such as “2 (interesting) 1 (a little interesting), 0 (normal), −1 (a little uninteresting), −2 (uninteresting)” by the evaluation button (62) are ranked in the top 30% of each registered product.

The advertisement poster may post the advertisement without paying the participation fee to the above-described charging means (121). In this case, however, the total amount of the participation fee may not be obtained as the award when the evaluation is high ranked and the advertisement poster wins the lottery, although the advertisement poster can obtain the reward from the client decided by the reward-decision means (18), and will not be selected as an subject of the second lottery means if meeting the certain evaluation standard.

The advertisement poster may choose whether they pay the participation fee to the charging means (121) or not for posting the advertisement.

The internet advertisement-posting system of the present invention is preferably applicable for the advertisement of the product.

What is claimed is:

1. An internet advertisement-posting system comprising:
a server for managing and publishing an advertisement for a registered product requested by a client via a client terminal;
an advertisement poster terminal for posting the advertisement on the server; and
a viewer terminal for viewing the advertisement managed by the server, the server, the advertisement-poster terminal and the viewer terminal connected each other via a network, wherein the server comprises:
a receiving means for receiving the advertisement posted from the advertisement poster terminal;
a publishing means for publishing the advertisement as requested by the viewer terminal;
an evaluation-request means for requesting the viewer terminal to evaluate the viewed advertisement;
an evaluation-decision means for counting the evaluation obtained from the evaluation-request means so as to decide a comprehensive evaluation;
a processing means for processing the advertisement based on an evaluation obtained from the evaluation-decision means; and
a reward-decision means for deciding a reward for an advertisement poster depending on the comprehensive evaluation obtained from the evaluation-decision means.

2. The internet advertisement-posting system in claim 1, wherein the published advertisement by the publishing means is a banner advertisement linked to the client terminal.

3. The internet advertisement-posting system in claim 2, wherein the receiving means is able to receive the advertisement from the client terminal,
wherein the publishing means alternately publishes the advertisement posted from the advertisement poster terminal and stored in the server and the advertisement provided from the client terminal as the banner advertisement.

4. The internet advertisement-posting system in claim 3, wherein the publishing means comprises a counter for a number of visitors to the banner advertisement and alternately publishes advertisements posted from the advertisement poster terminal and stored in the server and the advertisement provided by the client terminal every certain period,
wherein the advertisement with a lot of number of visitors during the certain period is selected by the processing means to be published.

5. The internet advertisement-posting system in claim 1, wherein the advertisement includes an advertisement for a non-registered product.

6. The internet advertisement-posting system in claim 1, wherein the publishing means comprises:
subdividing advertisements posted by the advertisement poster terminal into predetermined categories; and
publishing the subdivided advertisement, respectively.

7. The internet advertisement-posting system in claim 1, wherein the publishing means comprising:
subdividing advertisements for the registered product and for the non-registered product into different categories; and
publishing the subdivided advertisement, respectively.

8. The internet advertisement-posting system in claim 1, wherein the reward-decision means decides to reward the advertising poster terminal by a lottery in a certain period, said advertising poster terminal posting an advertisement with comprehensive evaluation over a certain level by the evaluation-decision means.

9. The internet advertisement-posting system in claim 5, wherein the reward-decision means decides not to give the reward for the advertisement for the non-registered product.

10. The internet advertisement-posting system in claim 5, wherein the processing means deletes an advertisement for the registered product with a comprehensive evaluation under a certain level by the evaluation-decision means after over second certain period from a posting time and an advertisement for the non-registered product after third certain period from the posting time.

11. The internet advertisement posting system in claim 1, wherein the reward decided by the reward-decision means is given to the advertisement poster terminal from the server without involving the client terminal.

12. The internet advertisement posting system in claim 1, wherein the server comprises: a charging means for charging a participation fee on the advertisement poster terminal; and a lottery means,
wherein the lottery means rewards a total amount of a participation fee to the advertisement poster terminal selected by a lottery after the charging means confirms the payment of the participation fee from the advertisement poster terminal, said advertisement poster terminal posting the advertisement given an evaluation over a certain level of each registered product by the evaluation decision means.

13. The internet advertisement posting system in claim 12, wherein the server comprises a saving means for saving a part of the participation fee,
wherein the lottery means rewards a total amount of a part of participation fee saved in the saving means by a second lottery to all the advertisement poster terminal after charging means confirms the payment of the participation fee from the advertisement poster terminal, said advertisement poster terminal posting the advertisement with an evaluation over a certain standard by the advertisement poster terminal.

14. The internet advertisement posting system in claim 1, wherein the server is connected to a substitutional publishing server for receiving and publishing the advertisement transmitted from the server via a network.
